(19) United States
(12) Patent Application Publication
(10) Pub. No.: US 2025/0165240 A1
(43) Pub. Date: May 22, 2025

(54) ORCHESTRATION OF AGENT-BASED CYBERSECURITY ENDPOINT DEPLOYMENTS

(71) Applicant: Metabase Q, Inc., San Francisco, CA (US)

(72) Inventors: Federico Nan, Los Angeles (CL); Mauricio Benavides, CDMX (MX); Jorge Damián Failla, Entre Ríos (AR); Louise Ireland, San Francisco, CA (US)

(73) Assignee: Metabase Q, Inc., San Francisco, CA (US)

(21) Appl. No.: 18/948,608

(22) Filed: Nov. 15, 2024

Related U.S. Application Data
(60) Provisional application No. 63/711,191, filed on Oct. 24, 2024.
(60) Provisional application No. 63/599,884, filed on Nov. 16, 2023.

(51) Int. Cl. G06F 8/61

(52) U.S. Cl. CPC G06F 8/61

(57) ABSTRACT

A processor-implemented method for software deployment is disclosed. A software agent is installed on endpoint devices in a network. Each software agent manages a unique endpoint device and communicates to orchestration software. The software agent provides access to one or more third-party applications running on the endpoint devices. The third-party applications communicate with the software agent running on the endpoint devices via an application programming interface (API). The software agent monitors the endpoint device activity generated by the third-party applications. The agent can send security information details from the endpoint device and the third-party applications to the orchestration software. The orchestration software can summarize the security information details from the endpoint devices and initiate actions on one or more of the endpoint devices when suspicious activity is detected. Actions can include blocking suspicious activities, and installing, updating, or removing software.

### RELATED APPLICATIONS

This application claims the benefit of U.S. provisional patent applications “Orchestration Of Agent-Based Cybersecurity Endpoint Deployments” Ser. No. 63/599,884, filed Nov. 16, 2023, and “Proactive Security Assessment With Agent-Based Cybersecurity Deployment” Ser. No. 63/711, 191, filed Oct. 24, 2024.

Each of the foregoing applications is hereby incorporated by reference in its entirety.

### FIELD OF ART

This application relates generally to software deployment and more particularly to orchestration of agent-based cybersecurity endpoint deployments.

### BACKGROUND

Psychologist Abraham Maslow created a hierarchy of human needs in the 1940s. Maslow proposed that after the most basic physical needs such as food, water, air, and shelter are met, the next greatest set of needs for humans is safety and security. Humans have deep-seated desires for physical health, emotional security, financial security, social stability, freedom from fear, and safety against accidents and injury. According to Maslow, humans will work hard to secure and protect these needs before they can progress to forming strong interpersonal relationships; developing feelings of self-worth, accomplishment, and respect; and reaching one's true potential. When security is threatened or lost, an individual or group will work hard to reestablish safety for themselves and those in their care.

Physical safety is about being secured from accidents, injuries, and environmental hazards. People wear seat belts, practice safe driving habits, hold handrails, wear proper clothing for the weather, and follow safety rules and procedures at work. At home and at the office, we install security systems, put strong locks on doors and windows, buy fire extinguishers, and create emergency evacuation plans. Our cities and towns employ police forces and firefighters, retain emergency medical technicians, and enable community watch groups. States have national guards who train for everything from evacuation procedures to civil defense. Countries have standing armies, navies, air forces, space forces, coast guards, border patrols, highway patrols, and so on.

Psychological safety refers to feeling free from fear, anxiety, and stress. Humans want to feel safe and supported in their environments, whether at home, work, school, or in other social gatherings. Feelings of safety and security can be harder to achieve, even when physical security practices are objectively in place. News stories about local crimes, illnesses, threatening weather patterns, and even potholes in roadways can all contribute to feelings of fear and anxiety. These feelings can lead to the desire to take actions to deal with the threats, whether real or imagined. People install more locks on their doors, add cameras to their entryways, carry weapons and repellants for personal protection, take self-defense classes, install apps on their phones to warn them of weather or traffic issues, and so on. Others work to minimize their exposure to threats; travel outside of their homes only when necessary; never travel alone; and seek out the safest cities, the lowest-crime neighborhoods, or the least populated areas of the country in which to live. Entire websites are devoted to locating the safest places in various regions of the world, based on personal criteria for safety and security. Social and political tensions can create environments of instability and uncertainty, impacting both individual and collective safety. For example, many are fearful of riots and social instability as we move through our national election cycle.

In today's complex and interconnected world, ensuring safety and security presents numerous challenges. Computer systems, mobile phones, digital networks, and the internet have brought incredible advances in our ability to interconnect and do business across the street or on the other side of an ocean. Paradoxically, technological advancements can go both ways, as the rise of cybercrime and the proliferation of surveillance technologies has introduced new threats to both physical and digital security. Whether in the physical or digital world, our basic human needs for safety and security persist. Humans must continue to work together in order to create a safer and more secure future for all.

### SUMMARY

Network security can be a continual process, requiring diligence, quick responses, and coordinated efforts in order to protect all points of a network and repair breaches as rapidly as possible. Investigating suspicious activity, keeping user devices up to date, deploying updates and patches, monitoring software activity, and reporting progress to users and security staff are all vital functions in providing comprehensive security maintenance. Many networks deploy multiple layers of hardware and software in order to provide a balanced and complete security umbrella for end users across a network, regardless of where they are located or how they connect. The software programs and agents which are installed on endpoints in order to keep these devices up to date and to monitor them for any signs of problems often come from multiple vendors. Keeping the applications on the endpoints current and coordinating efforts when a problem or even a suspicious activity occurs can be challenging. Multiple flags, alerts, communications, and actions can be generated in rapid succession when a security event arises. Orchestrating the responses to a suspicious action across one or multiple endpoint devices can require coordination, flexibility, and solid communications with many third-party applications simultaneously.

A processor-implemented method for software deployment is disclosed comprising: installing a software agent on each endpoint device within a plurality of endpoint devices, wherein each software agent remotely manages a unique endpoint device within the plurality of endpoint devices, and wherein each software agent is communicatively coupled to an orchestration software running on a compute device; providing software access, wherein the software access enables, on one or more endpoint devices within the plurality of endpoint devices, one or more third-party applications, and wherein the one or more third-party applications communicate with each software agent installed on the one or more endpoint devices; monitoring, by a first software agent installed on a first endpoint device within the one or more endpoint devices, an activity by the one or more third-party applications on the first endpoint device; sending, to the orchestration software, by the first software agent, a plurality of security information details, wherein the plurality of security information details includes the activity that was monitored; summarizing, by the orchestration software, the plurality of security information details from the first software agent; and taking an action, on the first endpoint device, wherein the action is based on the summarizing, wherein the action is initiated by the orchestration software, and wherein the action is performed by the first software agent.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for agent-based security deployment.

FIG. 2 is a flow diagram for responding to suspicious activity.

FIG. 3 is an infographic for agent-based cybersecurity deployment.

FIG. 4 is a block diagram for installing software.

FIG. 5 is a block diagram for blocking suspicious activity.

FIG. 6 is an example of monitoring coverage of installed third-party software.

FIG. 7 is an example of blocking suspicious activity.

FIG. 8 is a system diagram for agent-based cybersecurity deployment.

### DETAILED DESCRIPTION

Computer security can be an ongoing endeavor for individuals and organizations alike. The number and complexity of computer system threats has led to multiple solutions and applications that specialize in particular sectors of IT network and endpoint security. It is not unusual for personal computers, laptops, or private cell phones to have multiple security applications installed and running in the background. Corporate and government networks use even more security software and hardware from multiple vendors. It is common for a network to devote more time, money, and computing resources to cybersecurity than to core business applications and operations. Network endpoint devices, whether wired or wireless, can have several different security applications installed, often from third parties and in some cases with overlapping features and functions. Coordinating the efforts of the different applications on endpoint devices in order to maintain and protect users and their systems can be a difficult task.

Techniques for software deployment are disclosed. A software agent is installed on each unique endpoint device in a computer network. The endpoint devices can be coupled to the network using either wired or wireless means. The devices themselves can be virtual workstations, personal computers, laptops, desktops, pads, tablets, cell phones, or other devices that can access the network and run applications. The software agent can use application programming interfaces (APIs) to access and control third-party applications on the endpoint device, including business applications, security programs, and other agents. The software agent is also communicatively coupled to network-based orchestration software that can take in security information from every endpoint device coupled to the network and coordinate security planning and responses to cybersecurity threats. The software agent can also deploy security applications such as antivirus or anti-ransomware software directly when third-party software does not provide all necessary coverage on an endpoint device. The software agent actively monitors all activity on each endpoint device, including operating and network system operations, business applications, and cybersecurity programs. The orchestration software can manage deployments of updates and patches to the endpoints using predetermined schedules, on-demand requests generated by security staff, or responses to ongoing security threats.

When suspicious activity occurs on one or more endpoint devices, the software agent can monitor all flags, alerts, communications, and actions generated by the third-party applications running on the device. This information can be relayed to the orchestration software which analyzes the event and sends coordinated responses to the endpoint devices involved. Suspicious events can generate multiple flags, often overlapping, from different third-party applications running on each endpoint device. Information and decision making can become complicated for even a single endpoint due to the number of applications involved. When multiple endpoints are involved, a security staff can be inundated with information and requests for decisions to be made in a short time. The orchestration software was designed for just such scenarios. It can asynchronously communicate with each endpoint device, consuming and analyzing the many details generated by multiple applications, and responding with commands designed to minimize the impact of cybersecurity events as they occur. Software applications can be installed, updated, or removed; actions can be taken or halted; infected files or programs can be quarantined for later study; and so on. The value of such coordination becomes apparent as soon as the first attack on one or more endpoints in a valuable network occurs. The work of the orchestration software and the endpoint software agents can be an enormous asset in keeping a network secure and its users focused on core business operations.

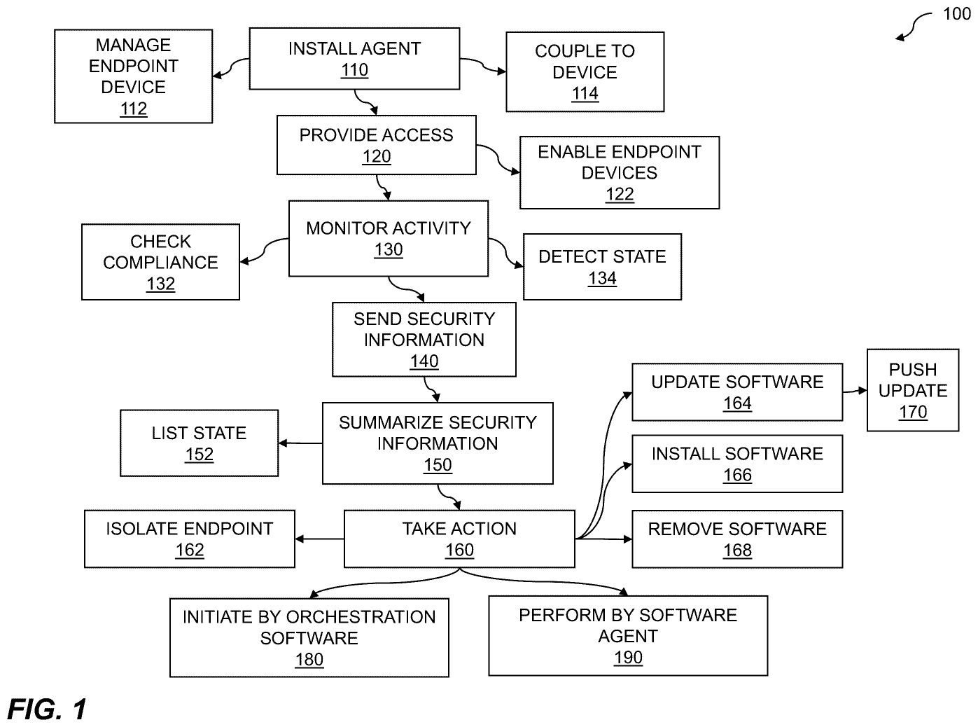

FIG. 1 is a flow diagram 100 for agent-based cybersecurity deployment. The flow 100 includes installing 110 a software agent on each endpoint device within a plurality of endpoint devices, wherein each software agent remotely manages a unique endpoint device 112 within the plurality of endpoint devices, and wherein each software agent is communicatively coupled 114 to an orchestration software running on a compute device. The endpoint devices can be personal computers, laptops, thin-client workstations, tablets, mobile phones, IoT devices, network components, and so on. The endpoint device connections can be wired or wireless. The network environment can be local, cloud, hybrid clouds, etc. A software agent can be a computer program that can act with a level of autonomy under a defined set of circumstances. Software agents can be persistent; they can be proactive and reactive, and can act independently or in collaboration with other software components on the same device or other devices. In embodiments, the software agent can send and receive messages from the orchestration software. The compute device hosting the orchestration software can be a mobile device.

The flow 100 includes providing a software access 120, wherein the software access enables, on one or more endpoint devices 122 within the plurality of endpoint devices, one or more third-party applications, and wherein the one or more third-party applications communicate with each software agent installed on the one or more endpoint devices. In embodiments, the providing includes an application programming interface (API). The API can be provided to the one or more third-party applications. The software access can allow a user to communicate with and control the one or more third-party applications through the software agent. The third-party applications can interact with the software agent, the orchestration software, or the user. The third-party applications can accept and execute commands, generate reports and logs, communicate with other applications, and so on without requiring a separate login or user access session. The API interface to the third-party applications can allow the software agent and the orchestration software to monitor and control the third-party applications without invoking a separate application session for the third-party programs on the endpoint device.

In embodiments, the software agent includes security functions including antivirus, endpoint detection and response (EDR), incident response, anti-ransomware, advanced persistent threat (APT), and so on. The software agent can interact with the included security functions and can monitor and control their actions. The software agent can communicate with the orchestration software to report activity detected by the security functions in the same way that it can communicate information from the third-party applications. The software agent can act using the software functions in coordination with the orchestration software, or independently, based on suspicious activity detected by the software agent.

The flow 100 includes monitoring 130, by a first software agent installed on a first endpoint device within the one or more endpoint devices, an activity by the one or more third-party applications on the first endpoint device. The monitoring can include reviewing log entries generated by the third-party applications, communications sent to or from the third-party application to a server or cloud-based control application, alerts generated by a third-party agent on the endpoint device, and so on. In embodiments, the monitoring comprises checking 132, by the first software agent, a compliance of the first endpoint device against a security standard. The security standard can be associated with internal policies; regulatory, audit, or third-party organization recommendations; and so on. The security standards can include the ISO 27000 series, NIST SP 800-53, NIST SP 800-171, COBIT, CIS Version 8, HITRUST, and so on. Recommendations from the third-party application vendor can be used as a security standard. The checking can be based on a schedule. The schedule can be set for individual third-party applications or can be based on a standard for application types.

In embodiments, the monitoring includes detecting 134 a state of the one or more third-party applications running on the first endpoint device. In some embodiments, the state of the one or more third-party applications includes an identification of a suspicious activity, a software version, or a connection status. For example, the application state can show normal operation, an error message, communications problems, and so on. The version of the third-party application, install date, hours or days of continuous operations, and so on can be included in the program state information. In embodiments, alerts or other responses to suspicious activity are generated by the third-party applications and monitored by the software agent and control applications or devices associated with the third-party application at the same time.

The flow 100 includes sending 140, to the orchestration software, by the first software agent, a plurality of security information details, wherein the plurality of security information details includes the activity that was monitored. The plurality of security information details can include the endpoint device hostname, IP address, kernel, agent version, agent status, or a last internet connection. Information about the type of endpoint device, operating system, network connection, physical location, and so on can be included in the plurality of security information details. The plurality of security information details can be refreshed based on a schedule established by the orchestration software. Alerts and other responses to suspicious activity or security incidents can be sent to the orchestration software as soon as the responses are generated by the software agent on the endpoint device. In embodiments, the first software agent and the second software agent communicate with the orchestration software asynchronously. This can allow the orchestration software the ability to communicate with multiple endpoint devices simultaneously and coordinate actions to remedy security incidents quickly and efficiently.

The flow 100 includes summarizing 150, by the orchestration software, the plurality of security information details from the first software agent. Summarized information can include the number of endpoint devices on the network, number of active endpoint devices, number of security related events, number of blocked commands, number of allowed commands, and so on. The summarizing can include listing 152 the state of the one or more third-party applications running on the first endpoint device. In embodiments, the state of the one or more third-party applications includes an identification of a suspicious activity, a software version, or a connection status. The summary of endpoint devices can include groups based on the type of device, departments, locations, types of incidents reported, and so on. The user can review the summarized categories and expand the summary to view details down to the individual endpoint device.

The flow 100 includes taking an action 160, on the first endpoint device, wherein the action is based on the summarizing, wherein the action is initiated 180 by the orchestration software, and wherein the action is performed 190 by the first software agent. In embodiments, the action is responsive to a security incident. In further embodiments, the action includes isolating 162 the first endpoint device. The orchestration software can remove the endpoint device from the network, shut down specific applications or services on the device, isolate specific files or programs, move files to a separate drive or device for research, and so on. In some embodiments, the orchestration software takes preemptive measures to prevent a security incident from spreading to other endpoint devices with similar characteristics. For example, all like endpoint devices in the same department as the first endpoint device can be isolated from the network, all endpoint devices running the same third-party application can be shut down, specific services on the endpoint devices can be disabled, and so on.

In embodiments, the action includes updating 164 a software application on the first endpoint device. In embodiments, the action further comprises pushing 170, by the first software agent, the software update to the first endpoint device. In some embodiments, the software update includes the one or more third-party applications installed on the first endpoint device. In embodiments, the action includes installing 166 a software application on the first endpoint device. In some embodiments, the action includes removing 168 a software application from the first endpoint device. Based on the security incident, the software agent and orchestrator software can install, update, uninstall, or remove third-party software as required. For example, a security incident can be created by a recent upgrade to a third-party application. The software agent can uninstall the upgrade or patch and return the third-party application to a functional, secure state. In embodiments, the agent pulls software updates from a central server in the network, a cloud server, or a vendor facility. The orchestrator software can push updates 170 from similar sources and then can communicate with the endpoint device software agent to complete and monitor the update process. Applications that have become outdated, or are being replaced by and offered from a different vendor, can be removed. The updates can be scheduled to run off-hours or, depending on the level of a security threat, can be installed immediately. The orchestrator software or software agent can generate notifications to the users regarding the timing of an upgrade, addition or removal of applications, or enabling the actions to be run in silent mode, so that the user can be unaware of any changes being made. As actions are completed by the software agent, the state of the endpoint device can be updated in the orchestration software by the agent.

In practice, a software agent can be installed on every endpoint device included in the network being monitored by the orchestration software. Each endpoint device can be monitored and controlled by the orchestration software based on security information received from the installed software agent. Thus, in embodiments, the flow 100 includes monitoring, by a second software agent installed on a second endpoint device within the one or more endpoint devices, an activity by one or more third-party applications on the second endpoint device; sending, to the orchestration software, by the second software agent, a plurality of security information details, wherein the plurality of security information details includes the activity that was monitored; summarizing, by the orchestration software, the plurality of security information details from the second software agent; and taking an action, on the second endpoint device, wherein the action is based on the summarizing, wherein the action is initiated by the orchestration software, and wherein the action is performed by the second software agent. In this way, the entire network can be monitored. Further, the installation of a software agent on every endpoint device can enable the orchestration software to report an action, take an action, or update software on any endpoint device in the network.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

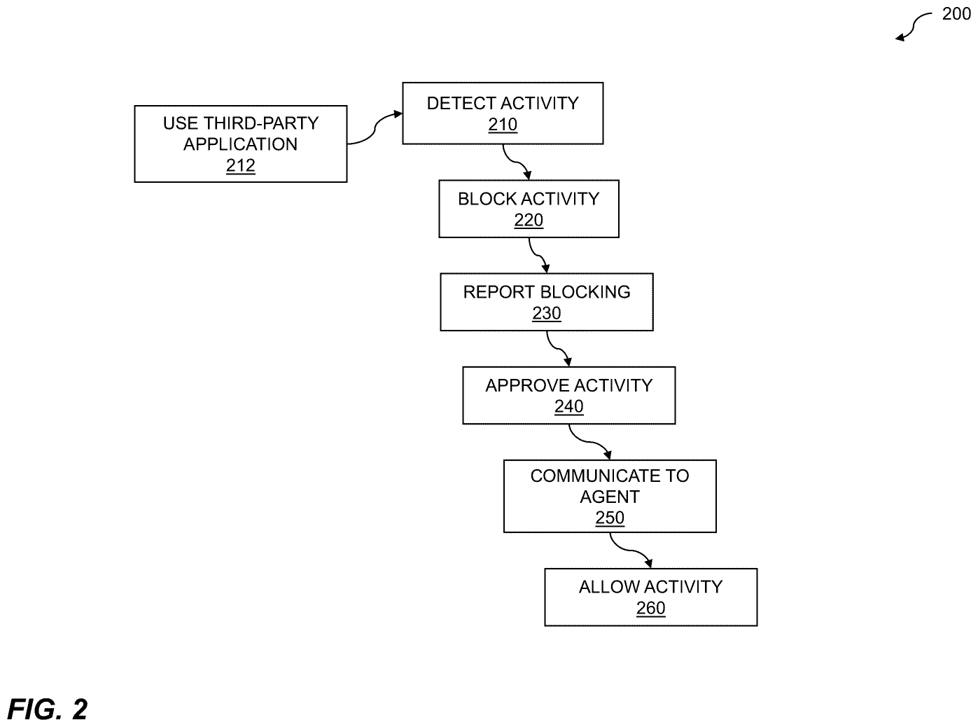

FIG. 2 is a flow diagram 200 for responding to suspicious activity. The flow 200 includes detecting 210, on the first endpoint device, by the one or more third-party applications 212, a suspicious activity on the first endpoint device. In embodiments, the suspicious activity is detected by one or more of the third-party applications installed on the first endpoint device. The suspicious activities can include a virus in an email, email attachment, program, or file; a ransomware attack; unusual response times; abnormal drive activity; unusual internet traffic; pop-up messages; and so on. In embodiments, the detecting further comprises quantifying the suspicious activity and providing results of the quantifying to the orchestration software. For example, the number of emails or files affected by a virus, the number of attempts to write files to a drive, and so on can be reported to the orchestration software. In the case of a virus infecting multiple endpoint devices, the total number of devices impacted, the amount of time elapsed from the first detection, etc. can be compiled by the orchestration software as part of the quantifying process.

The suspicious activity can be detected by one or more of the third-party applications, or by the software agent itself. Suspicious activity can be detected by multiple applications at the same time. In some embodiments, the suspicious activity generates multiple types of events that are detected and reported by one or more third-party applications. For example, a virus attack can generate suspicious activity in the memory of an endpoint as well as abnormal file activity and network connections. Different third-party applications may detect one or more of the suspicious events generated by the virus and report them to the user or a software management application. The software agent can capture and forward all of the logs, flags, and suspicious activity reports generated by the third-party applications and can forward them to the orchestration software.

The one of more third-party applications can include antivirus software, endpoint detection and response (EDR) software, incident response software, anti-ransomware, or advanced persistent threat (APT) software. Other third-party applications can be included. Antivirus or anti-malware applications are computer programs designed to prevent, detect, and remove malicious software viruses, worms, trojans, adware, and so on. They can scan files, directories, and memory for malware or known malware patterns and report any suspicious findings to the user or management software. EDR software records all activities and events occurring on endpoint devices, including active and passive workloads, and reports any unusual or suspicious activity in real time. It can detect events such as process creation, driver loads, registry modifications, disk access, memory access, and network connections. Incident response software can be used to automate the process of finding and resolving security breaches. Networks can monitor cloud connections, infrastructure, and endpoints for intrusions and abnormal activity. They then use the incident response programs to inspect and resolve intrusions and malware in the system. These products can provide capabilities to resolve issues that arise after threats have bypassed firewalls and other security mechanisms. They can alert administrators of unapproved access of applications and networks. Anti-ransomware applications can protect endpoint devices and files from ransomware attacks. Ransomware can be a malicious program that encrypts data on endpoint and network devices and demands a ransom for the decryption key. APT applications can be software tools designed to identify and block sustained endpoint or network cyberattacks in which the intruder establishes an undetected presence in order to steal sensitive data over a prolonged period of time. Networks often use combinations of these third-party applications to provide a comprehensive web of monitoring and protection programs to secure all internal and endpoint users, programs, and data. Many of these applications have overlapping functions that can generate multiple flags and alerts when suspicious activity occurs. In embodiments, the software agent connects to the third-party applications using an application program interface (API) tailored to each application. The software agent can monitor all third-party applications installed on the endpoint device and send the security information details from each of them to the orchestration software when suspicious activity occurs.

The flow 200 includes blocking, by the one or more third-party applications, the suspicious activity 220. In embodiments, the default response of many third-party security applications is to block or halt any suspicious or unauthorized activity as soon as it is detected. For example, if an attachment in an email begins to write files or embedded programs into the memory of the endpoint device, the third-party application can block the file or program from being written. If a program execution generates background connections to an unknown internet-based location, the third-party application can halt the connection, block access to the network port being used, and so on. In some embodiments, the third-party application will take action to block suspicious activity before it notifies the user or related control applications of the action being taken. In other embodiments, the third-party application will suspend the suspicious activity temporarily while it reports the activity to control applications or orchestration software and waits for next action steps to be determined. In embodiments, the software agent monitors and detects the suspicious activity notifications as the one or more third-party applications detect potential threats.

The flow 200 includes reporting 230, by the first software agent, the blocking to the orchestration software. All of the flags, logs, alerts, and other security information generated by the third-party applications, including the blocking of suspicious activities, can be captured by the software agent and reported to the orchestration software. The orchestration software can take in all of the suspicious activity alerts and other information related to the event and coordinate the responses of the third-party applications installed on one or more endpoint devices. For example, the orchestration software can direct the third-party applications to block all aspects of a detected virus on an endpoint device.

The flow 200 includes approving, by a user, in the orchestration software, the suspicious activity 240. In embodiments, security personnel and endpoint users receive notifications from the orchestration software reporting the detected suspicious activity and the actions that have been taken. The notifications can be in the form of emails, voice messages, text messages, and so on. Security personnel can also view the suspicious activities using the monitoring screens of the orchestration software (described below). In some embodiments, the user views details, and can approve or alter actions recommended by the orchestration software by selecting links included in the text message or email notification. In embodiments, the user chooses to approve an activity that is detected on an endpoint device. For example, an internet site frequently used by endpoint devices can change its disaster recovery or alternate IP address ranges before all external facing firewalls are notified of the change. Many endpoint devices can generate security alerts when unauthorized IP address changes are detected while accessing an external website. The security personnel can review the reported suspicious activity in the orchestration software, verify that the detected external IP addresses are correct, allow the endpoint activity to access the website, and subsequently update the firewalls of the address changes.

The flow 200 includes communicating 250, by the orchestration software, to the first software agent, the approving. After the user has reviewed the suspicious activities detected by the software agent and reported them to the orchestration software, the user can choose to leave the blocking of the activity in place, allow the activity to proceed 260, or approve additional security steps, such as sequestering the suspicious programs or files. Once the decisions are made by the user, the orchestration software can communicate the appropriate actions to be taken to the software agent. The software agent can then direct the third-party applications using API calls to take the actions selected by the user. In some embodiments, the actions to be taken in some suspicious activity scenarios are configured in advance by the user in the orchestration software, so that approval from a human user is not required to complete routine responses. For example, known malware or virus programs that are detected on an endpoint device can be blocked and reported to the orchestration software without pausing to ask the user for approval. The orchestration software can respond to the anti-ransomware alerts immediately, can report the response to the user later, and so on.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

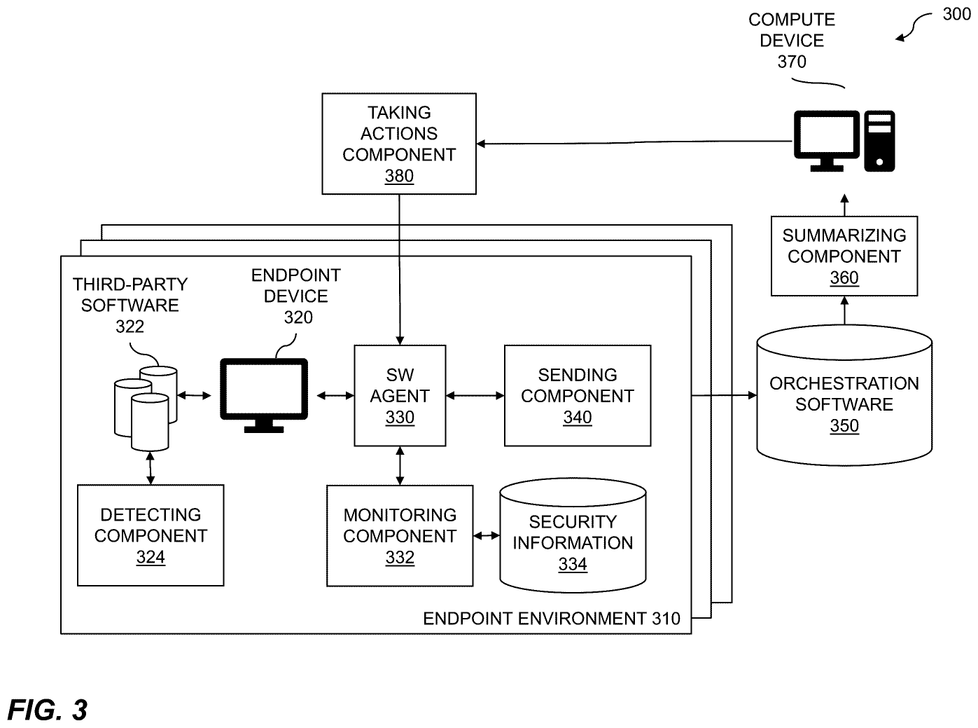

FIG. 3 is an infographic 300 for agent-based cybersecurity deployment. The infographic 300 includes an endpoint environment 310 and an endpoint device 320. In practice, a plurality of endpoint devices can be included in the endpoint environment. The endpoint environment can include one or more endpoint devices that can participate in a computer network. The endpoint environment can include endpoint devices, software programs or agents running on the endpoint devices, and so on. The endpoint device can be a personal computer, laptop, thin-client workstation, tablet, mobile phone, IoT device, etc. The endpoint device connections to the network can be wired or wireless. The network environment can be local, cloud, hybrid clouds, etc. The network can be a combination of network devices, including routers, switches, firewalls, servers, storage devices, printers, user workstations, endpoint devices, and so on.

In embodiments, a software agent 330 is installed on each endpoint device within a plurality of endpoint devices, wherein each software agent remotely manages a unique endpoint device within the plurality of endpoint devices, and wherein each software agent is communicatively coupled to orchestration software 350 running on a compute device 370. A software agent can be a computer program that can act with a level of autonomy under a defined set of circumstances. In embodiments, the software agent sends and receives messages from the orchestration software. The compute device 370 hosting the orchestration software can be a mobile device.

The flow 300 includes providing software access, wherein the software access enables, on one or more endpoint devices within the plurality of endpoint devices, one or more third-party applications 322, and wherein the one or more third-party applications communicate with each software agent installed on the one or more endpoint devices. In embodiments, the providing includes an application programming interface (API). The API can be provided to the one or more third-party applications. The software access allows the software agent to communicate with or control the one or more third-party applications. The third-party applications can interact with the software agent, the orchestration software, or a user. The third-party applications can accept and execute commands from the software agent, generate reports and logs, communicate with other applications, and so on without requiring a separate login or user access session. The API interface to the third-party applications allows the software agent and the orchestration software to monitor and control the third-party applications without invoking a separate application session for the third-party programs on the endpoint device

The infographic 300 includes a monitoring component 332. The monitoring component can include monitoring, by a first software agent installed on a first endpoint device within the one or more endpoint devices, an activity by the one or more third-party applications on the first endpoint device. The monitoring can include reviewing log entries generated by the third-party applications, security information 334 gathered by the third-party applications, communications sent to or from the third-party application to a server or cloud-based control application, alerts generated by a third-party agent on the endpoint device, and so on. In embodiments, the monitoring includes checking, by the first software agent, compliance of the first endpoint device against a security standard. The security standard can be associated with internal policies; regulatory, audit, or third-party organization recommendations; and so on. Recommendations from one or more third-party application vendors can be used as a security standard. The checking can be based on a schedule. The schedule can be set for individual third-party applications or can be based on a standard for application types.

The infographic includes a detecting component 324. The detecting component can detect, on the first endpoint device, by the one or more third-party applications, a suspicious activity. In embodiments, the monitoring includes detecting the state of the one or more third-party applications running on the first endpoint device. The state of the one or more third-party applications can include an identification of a suspicious activity, a software version, a connection status, etc. For example, the application state can show normal operation, an error message, communications problems, and so on. The version of the third-party application; install date, hours, or days of continuous operations; and so on can be included in the program state information. In embodiments, alerts or other responses to suspicious activity are generated by the third-party applications and monitored by the software agent and control applications or devices associated with the third-party application at the same time.

The infographic 300 includes a sending component 340. The sending component includes sending, to the orchestration software, by the first software agent, a plurality of security information details, wherein the plurality of security information details includes the activity that was monitored. The plurality of security information details can include the endpoint device hostname, IP address, kernel, agent version, agent status, or a last internet connection. Information about the type of endpoint device, operating system, network connection, physical location, and so on can be included in the security information details. The security information details can be refreshed based on a schedule established by the orchestration software. Alerts and other responses to suspicious activity or security incidents can be sent to the orchestration software as the responses are generated by the software agent on the endpoint device. The software agents installed on unique endpoint devices in the endpoint environment can communicate with the orchestration software asynchronously. This allows the orchestration software the ability to communicate with multiple endpoint devices simultaneously and coordinate actions to remedy security incidents quickly and efficiently.

The infographic 300 includes a summarizing component 360. The summarizing component includes summarizing, by the orchestration software, the plurality of security information details from the first software agent. The summarizing can include the state of the one or more third-party applications running on the first endpoint device. In embodiments, the state of the one or more third-party applications includes an identification of a suspicious activity, a software version, or a connection status. In embodiments, the summarizing component includes security information details from multiple endpoint devices included in the endpoint environment. Summarized information can include the number of endpoint devices on the network, number of active endpoint devices, number of security related events, number of blocked commands, number of allowed commands, and so on. The summary of endpoint devices can include groups based on the type of device, departments, locations, types of incidents reported, and so on. A user can review the summarized categories and expand the summary to view details down to the individual endpoint device.

The infographic 300 includes a taking actions component 380. The taking actions component includes taking an action, on the first endpoint device, wherein the action is based on the summarizing, wherein the action is initiated by the orchestration software, and wherein the action is performed by the first software agent. In embodiments, the action is responsive to a security incident. In further embodiments, the action includes isolating the first endpoint device. The orchestration software can remove the endpoint device from the network, shut down specific applications or services on the device, isolate specific files or programs, move files to a separate drive or device for research, and so on. In some embodiments, the orchestration software takes preemptive measures to prevent a security incident from spreading to other endpoint devices with similar characteristics. For example, all like endpoint devices in the same department as the first endpoint device can be isolated from the network, all endpoint devices running the same third-party application can be shut down, specific services on the endpoint devices can be disabled, and so on. The actions can include adding, updating, or removing software on one or more endpoint devices. The result can be a set of coordinated actions being taken across the endpoint environment to prevent security threats and to respond to incidents in a timely and comprehensive manner when they occur. The various third-party applications are orchestrated to work together and deal with security threats quickly and thoroughly.

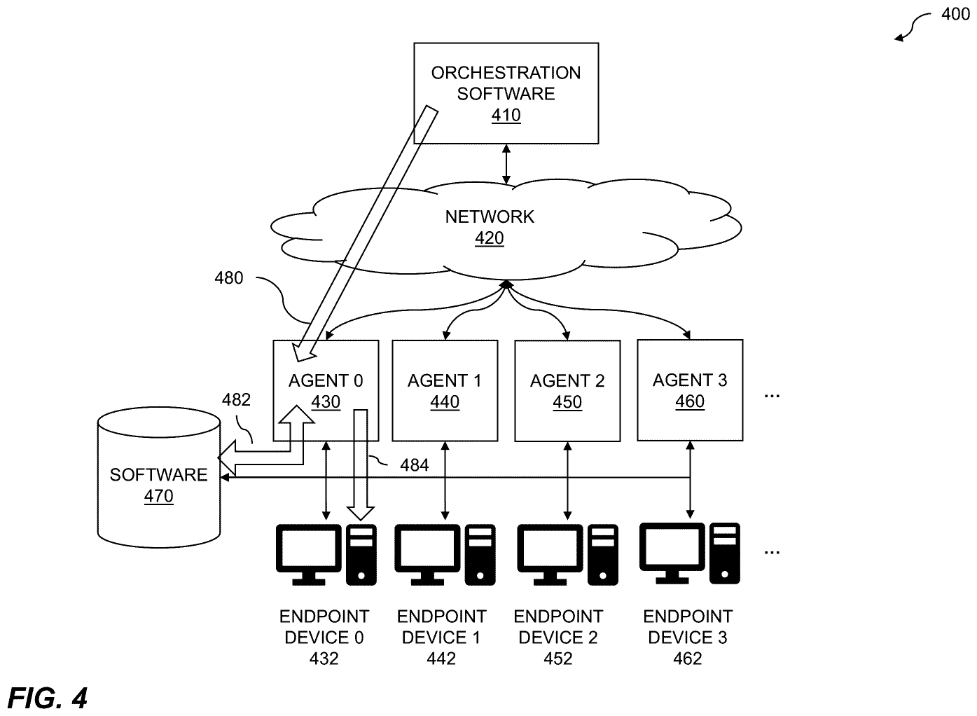

FIG. 4 is a block diagram for installing software. As described above and throughout, a software agent can be installed on each endpoint device within a plurality of endpoint devices. In the block diagram 400, agent 0 430 is installed on endpoint device 0 432, agent 1 440 is installed on endpoint device 1 442, agent 2 450 is installed on endpoint device 2 452, and agent 3 460 is installed on endpoint device 3 462. In practice, any number of endpoint devices with installed agents can be included. The endpoint device can comprise a personal computer, laptop, thin-client workstation, tablet, mobile phone, IoT device, and so on. In the block diagram, each of the agents is coupled to orchestration software 410. The coupling can include a network 420. The coupling can be accomplished through wired or wireless technology. The network environment can be based on a local network, cloud network, hybrid cloud network, etc. The network can be a combination of network devices, including routers, switches, firewalls, servers, storage devices, printers, user workstations, endpoint devices, and so on.

The software agents can monitor activities by one or more third-party applications on the endpoints. Security information details can be sent by any of the software agents to the orchestration software. The security information details include the activity that was monitored. The orchestration software summarizes the plurality of security information details from the software agents. An action is taken on one or more endpoint devices. The action is based on the summarizing. The action is initiated by the orchestration software. The action is performed by any agent.

In embodiments, the action includes installing a software application on the first endpoint device. Each agent within the block diagram 400 can have access to software 470. The software can comprise one or more text files, data files, internal applications or updates, third-party applications or updates, and so on. Third-party applications or updates can include antivirus software, endpoint detection and response (EDR) software, incident response software, anti-ransomware, advanced persistent threat (APT) software, etc.

In the block diagram 400, the orchestration software can determine that endpoint 0 432 does not have critical software running on it. For example, agent 0 430 can inform the orchestration software that endpoint device 0 is not currently running antivirus software, running an outdated version of the antivirus software, has an old file associated with the antivirus software, and so on. The orchestration software can take an action on endpoint device 0. In this example, the orchestration software can instruct 480 agent 0 430 to install the antivirus software, update, file, etc. on endpoint device 0. The action can be initiated by a user of the orchestration software. In response, the agent can fetch 482 the appropriate software 470 and install the software 484 on endpoint device 0. The installing can bring endpoint device 0 into compliance, closer into compliance, etc. to a security standard. In other embodiments, the action includes updating a software application on the first endpoint device. In this case, the agent can fetch the update and apply the update on the endpoint device.

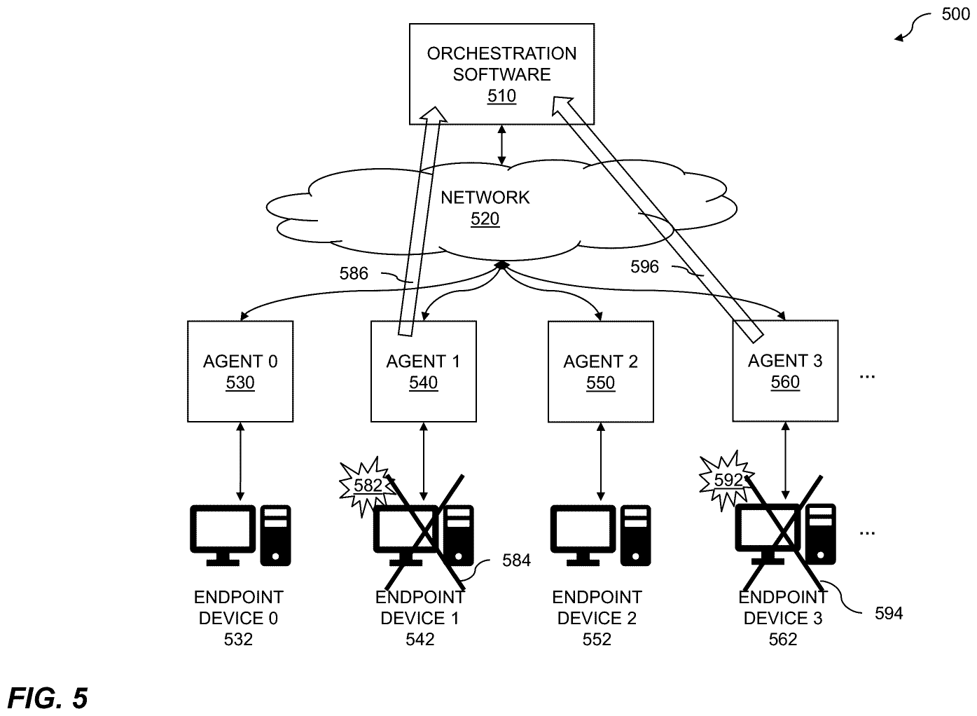

FIG. 5 is a block diagram for blocking suspicious activity. Software agents can monitor an activity, an application, a task, a third-party application, and so on running on any number of endpoint devices. In the block diagram 500, software agent 0 530 is installed on endpoint device 0 532, software agent 1 540 is installed on endpoint device 1 542, software agent 2 550 is installed on endpoint device 2 552, and software agent 3 560 is installed on endpoint device 3 562. Any number of endpoint devices can be included. The endpoint device can comprise a personal computer, laptop, thin-client workstation, tablet, mobile phone, IoT device, and so on. In the block diagram, each of the agents is coupled to orchestration software 510. The coupling can include a network 520. The endpoint device connections to the network can be wired or wireless. The network environment can be based on a local network, cloud network, hybrid cloud network, etc. The network can be a combination of network devices, including routers, switches, firewalls, servers, storage devices, printers, user workstations, endpoint devices, and so on. The software agents can monitor an activity, software, etc. on the endpoint device on which it is installed. The software can be a third-party application, an activity, a task, a process, an activity, an application, and so on.

Embodiments include detecting, on the first endpoint device, by the software agent, a suspicious activity on the first endpoint device. The suspicious activity can include events such as process creation, driver loads, registry modifications, disk access, memory access, network connections, and so on. A user can program and/or reprogram the orchestration software to include specific activities that can be classified, by any of the software agents, as suspicious activity on the corresponding endpoint device. The suspicious activity can be detected by one or more of the third-party applications installed on the endpoint devices, or by the software agent itself. Suspicious activity can be detected by more than one application. The suspicious activity can generate multiple types of events that are detected and reported by one or more third-party applications. For example, a virus attack can generate suspicious activity in the memory of an endpoint as well as abnormal file activity and network connections. Different third-party applications may detect one or more of the suspicious events generated by the virus and report them to the user or a software management application. The software agent can capture and forward all of the logs, flags, and suspicious activity reports generated by the third-party applications and forward them to the orchestration software.

In the block diagram, two software agents, agent 1 540 and agent 3 560 have detected suspicious activity. Agent 1 has detected a suspicious activity 582 on endpoint device 1 and agent 2 has detected a suspicious activity 592 on endpoint device 3. The suspicious activity can be reported 586, 596, by the respective agents, to the orchestration software. The suspicious activity can be blocked 584, 594. The blocking can be accomplished by the agent running on the corresponding endpoint device. The blocking can be accomplished by the orchestration software. Embodiments include blocking, by the orchestration software, the suspicious activity, wherein the blocking is based on the detecting.

One or more third-party applications running on an endpoint device can also be involved in the process leading to blocking the suspicious activity. Embodiments include identifying, on the first endpoint device, by the one or more third-party applications, a suspicious activity on the first endpoint device. Further embodiments include quantifying the suspicious activity and providing results of the quantifying to the orchestration software. For example, the number of emails or files affected by a virus, the number of attempts to write files to a drive, and so on can be reported to the orchestration software. In the case of a virus infecting multiple endpoint devices, the total number of devices impacted, the amount of time elapsed from the first detection, and so on can be compiled by the orchestration software as part of the quantifying process. Some embodiments include blocking, by the one or more third-party applications, the suspicious activity, wherein the blocking is accomplished by the first software agent. Other embodiments include reporting, by the first software agent, the blocking to the orchestration software. The reporting can include flags, logs, alerts, and other security information generated by the third-party applications, including the blocking of suspicious activities.

Embodiments include approving, by a user, in the orchestration software, the suspicious activity. The orchestration software can present information to the user to aid in the decision of whether to approve the suspicious activity. The information can include the activity that was blocked, log files, flags, an IP address, a process ID, and so on. The user can choose to approve the suspicious activity (e.g., allow the activity to proceed). The user can choose to leave the blocking of the activity in place (e.g., prevent the activity from proceeding). The user can implement additional security steps, such as sequestering the suspicious programs or files. Other actions can be performed by the user. The actions can be performed within the orchestration software. Embodiments include communicating, by the orchestration software, to the first software agent, the approving. Further embodiments include allowing, by the first software agent, the suspicious activity on the first endpoint device to proceed. In a usage example, an internet site frequently used by endpoint devices can change its disaster recovery or alternate IP address ranges before all external facing firewalls are notified of the change. Many endpoint devices can generate security alerts when unauthorized IP address changes are detected while accessing an external website. The user can review the reported suspicious activity in the orchestration software, verify that the detected external IP addresses are correct, allow the endpoint activity to access the website, and subsequently update the firewalls of the address changes.

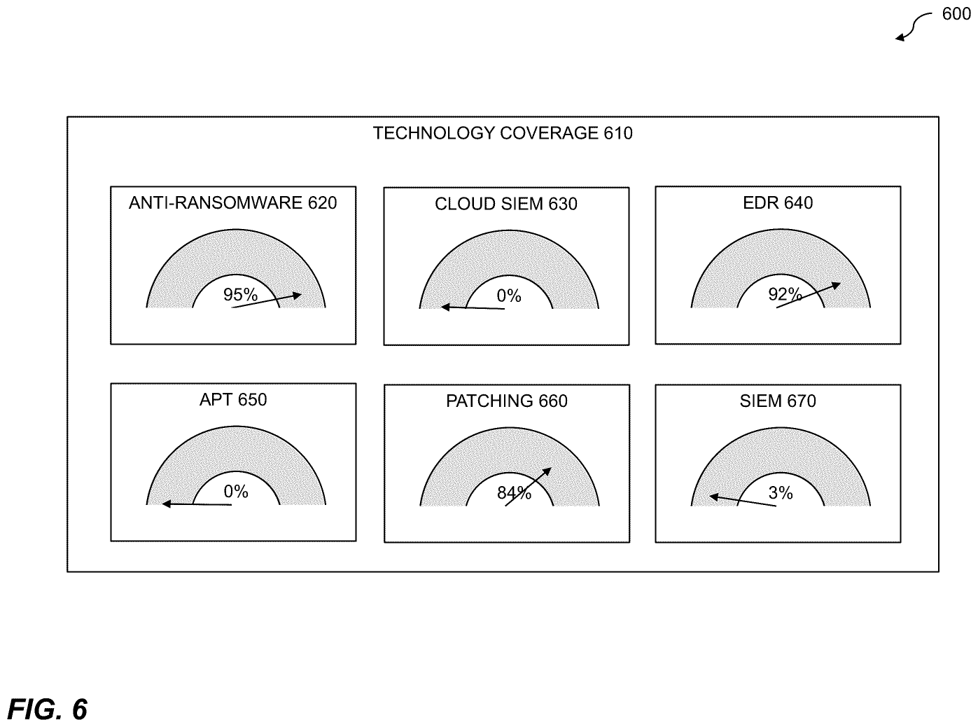

FIG. 6 is an example of monitoring coverage of installed third-party software. The example 600 includes technology coverage 610 of one or more endpoint devices within a plurality of endpoint devices. In embodiments, each unique endpoint device includes an installed software agent that is communicatively coupled to an orchestration software running on a compute device. Each software agent can access the installed third-party and internal applications and monitor the applications. The monitoring can include reviewing log entries generated by the third-party applications, communications sent to or from the third-party application to a server or cloud-based control application, alerts generated by a third-party agent on the endpoint device, and so on. In embodiments, the technology coverage includes monitoring, by a first software agent installed on a first endpoint device within the one or more endpoint devices, activities by one or more third-party applications on the first endpoint device. The monitoring further comprises monitoring, by a second software agent installed on a second endpoint device within the one or more endpoint devices, an activity by one or more third-party applications on the second endpoint device; sending, to the orchestration software, by the second software agent, a plurality of security information details, wherein the plurality of security information details includes the activity that was monitored; and summarizing, by the orchestration software, the plurality of security information details from the second software agent. In embodiments, a software agent is installed on every endpoint device included in the network being monitored by the orchestration software. Each endpoint device can be monitored and controlled by the orchestration software based on security information received from the installed software agent.

In embodiments, the monitoring comprises checking, by the one or more software agents, compliance of the endpoint devices against a security standard. The security standard can be associated with internal policies; regulatory, audit, or third-party organization recommendations; and so on. The security standards can include the ISO 27000 series, NIST SP 800-53, NIST SP 800-171, COBIT, CIS Version 8, HITRUST, and so on. Recommendations from the third-party application vendor can be used as a security standard. The checking can be based on a schedule. The schedule can be set for individual third-party applications or can be based on a standard for application types. In embodiments, the schedule includes software patches and updates from the third-party application vendors, operating system vendors, etc. The orchestration software can maintain an inventory of current updates, patches, and installation programs for the software installed on the endpoints included in the technology coverage umbrella, and can compare the versions of applications installed on the endpoint devices to the most current versions of each application. The summarized information regarding upgrade and patching levels can be displayed as a patching indicator 660 in the technology coverage example. In the example, the overall patching level indicates that 84% of the endpoint devices have the most current versions of applications patches installed.

The example 600 includes summarizing, by the orchestration software, the plurality of security information details from the first software agent. Summarized information can include the number of endpoint devices on the network, number of active endpoint devices, etc. Embodiments include a number of security related events, a number of blocked commands, a number of allowed commands, and so on. In embodiments, the summarizing comprises listing the state of the one or more third-party applications running on the first endpoint device. In embodiments, the state of the one or more third-party applications includes an identification of a suspicious activity, a software version, or a connection status. In embodiments, the summary of endpoint devices includes groups based on the type of device, departments, locations, types of incidents reported, and so on. The user can review the summarized categories and expand the summary to view details down to the individual endpoint device. In embodiments, the user chooses the summarized categories to display in a list or in graphic form. The list can be sorted as the user chooses. The order of the graphic indicators can be arranged by the user, as well as the color and patterns used within the indicators.

The summarized information for the one or more third-party applications can include antivirus software, endpoint detection and response (EDR) software 640, incident response software, anti-ransomware, or advanced persistent threat (APT) software. The one or more third-party applications can include security information and event management (SIEM) software, cloud security information and event management software, and patching software. In the example 600, the anti-ransomware indicator 620 shows that 95% of the endpoint devices included in the technology coverage umbrella have the anti-ransomware agent properly installed. In the example 600, the cloud SIEM 630 indicators show that there are no alerts or other indicators of suspicious activity present for any endpoint devices coupled to the network via a cloud connection. On the other hand, the SIEM indicator 670 shows that 3% of the endpoint devices coupled to the on-premises network are showing an alert or some other form of suspicious activity at the present time. Some of the suspicious activity can be related to an incomplete patching in process, or there can be some other form of activity taking place.

In the example 600, the endpoint detection and response (EDR) 640 indicator shows that 92% of the endpoint devices included in the technology coverage umbrella have the EDR application correctly installed and communicating with the software agent. The advanced persistent threat (APT) indicator 650 shows that there are currently no advanced threats being detected across the network. A user can mouse-click on one or more of the summary indicators and drill down into the data supporting the aggregated percentages. The data can be broken down by location, device type, operating system version, third-party application, suspicious activity, threat level, and so on. The user can drill down to the individual endpoint device and make decisions regarding the management of the endpoint (discussed below).

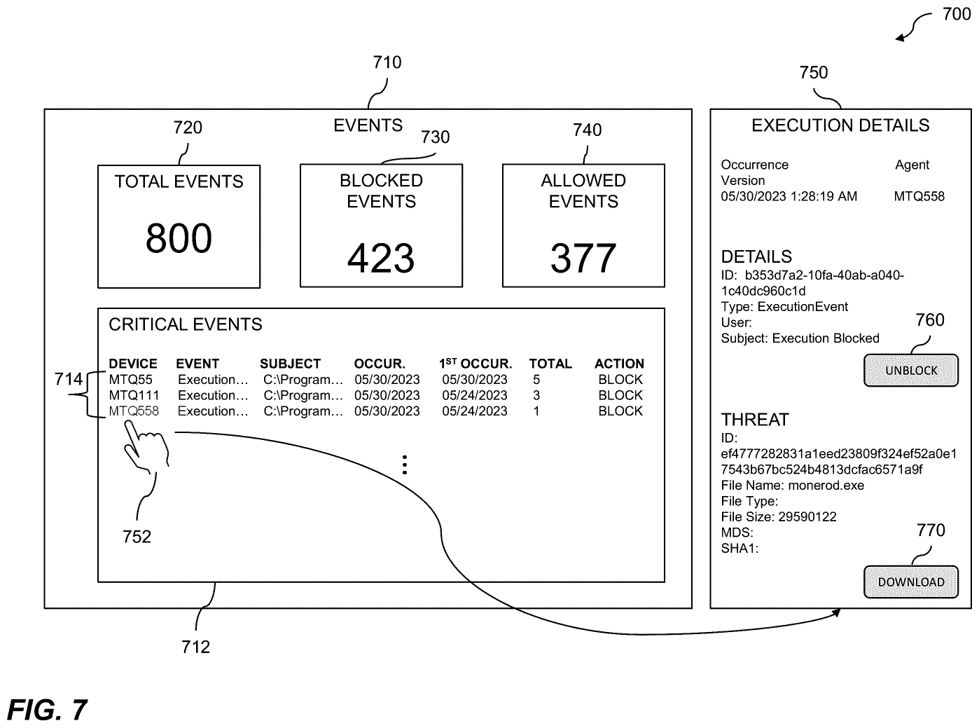

FIG. 7 is an example of blocking suspicious activity. The example 700 can include summarizing, by the orchestration software, the plurality of security information details from the first software agent. The example can further comprise monitoring, by a second software agent installed on a second endpoint device within the one or more endpoint devices, an activity by one or more third-party applications on the second endpoint device; sending, to the orchestration software, by the second software agent, a plurality of security information details, wherein the plurality of security information details includes the activity that was monitored; and summarizing, by the orchestration software, the plurality of security information details from the second software agent. In embodiments, the orchestration software aggregates the plurality of security information details and events 710 from all software agents installed on the one or more endpoint devices in the network. The summarizing can include event categories including total events 720, blocked events 730, and allowed events 740.

The example 700 can include a list of critical events 712 generated by one or more endpoint devices and detected by the one or more third-party applications running on the endpoint devices. The critical events can include one or more suspicious activities detected by the one or more third-party applications. The example 700 can include quantifying the suspicious activity and providing results of the quantifying to the orchestration software. In the example 700, three endpoint devices are listed 714. Each occurrence includes the name of the endpoint device, the type of event detected, the file or program comprising the subject of the event, the date of the most recent occurrence, the date of the first occurrence, the total number of times the event has occurred on the endpoint device, and the action or actions taken by the orchestration software in response to the event.

The example 700 includes monitoring, by a first software agent installed on a first endpoint device within the one or more endpoint devices, an activity by the one or more third-party applications on the first endpoint device. In the example 700, a user has selected 752 endpoint device MTQ558 to view execution details related to the device. The plurality of security information details 750 can include a hostname, IP address, kernel, agent version, agent status, or a last internet connection. In the example 700, the execution details show the date and time of the occurrence; the agent name; details from a security log including the ID of the event, the type of event, a threat ID, the file name, and/or file size; and so on. The user can be given the option of unblocking 760 the execution of the file monerod.exe and downloading 770 a copy of the file into a sandbox or other type of secured file area for further inspection and testing.

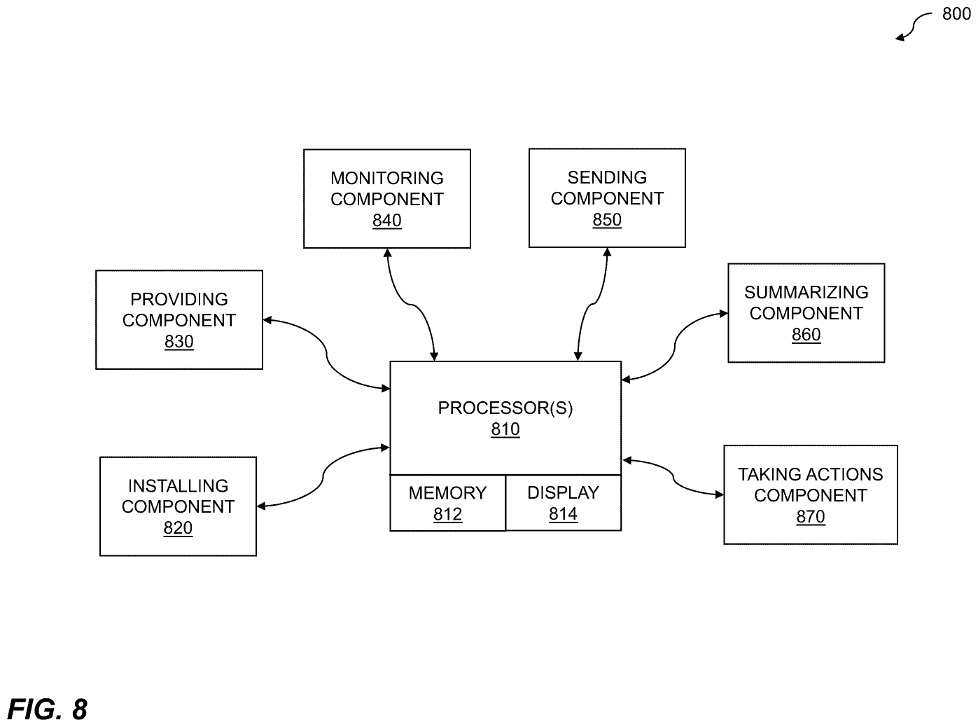

FIG. 8 is a system diagram for agent-based cybersecurity deployment. The system 800 includes one or more processors 810 coupled to a memory 812 which stores instructions. The system 800 includes a display 814 coupled to the one or more processors for displaying data, database information, programming details, intermediate steps, instructions, and so on. The system 800 includes an installing component 820. The installing component includes functions and instructions for installing a software agent on each endpoint device within a plurality of endpoint devices, wherein each software agent remotely manages a unique endpoint device within the plurality of endpoint devices, and wherein each software agent is communicatively coupled to an orchestration software running on a compute device. The software agent is a computer program that can act with a level of autonomy under a defined set of circumstances. The agent can be persistent, it can be proactive and reactive, and it can act independently or in collaboration with other software components on the same device or other devices, including the orchestration software. The endpoint devices can be personal computers, laptops, thin-client workstations, pads, tablets, mobile phones, IoT devices, and so on. The endpoint device connections can be wired or wireless. The network environment can be local, cloud, hybrid clouds, etc. In embodiments, the software agent sends and receives messages from the orchestration software. The compute device hosting the orchestration software can be a mobile device. The compute device can be a local server or a server based in a cloud environment.

The system 800 includes a providing component 830. The providing component includes functions and instructions for providing software access, wherein the software access enables, on one or more endpoint devices within the plurality of endpoint devices, one or more third-party applications, and wherein the one or more third-party applications communicate with each software agent installed on the one or more endpoint devices. In embodiments, the providing includes an application programming interface (API). The API can be provided to the one or more third-party applications. The software access can allow a user to communicate with and control the one or more third-party applications through the software agent. The third-party applications can interact with the software agent, the orchestration software, or the user. The third-party applications can accept and execute commands, generate reports and logs, communicate with other applications, and so on without requiring a separate login or user access session. The API interface to the third-party applications allows the software agent and the orchestration software to monitor and control the third-party applications without invoking a separate application session for the third-party programs on the endpoint device.

The system 800 includes a monitoring component 840. The monitoring component includes functions and instructions for monitoring, by a first software agent installed on a first endpoint device within the one or more endpoint devices, an activity by the one or more third-party applications on the first endpoint device. The monitoring can include reviewing log entries generated by the third-party applications, communications sent to or from the third-party application to a server or cloud-based control application, alerts generated by a third-party agent on the endpoint device, and so on. In embodiments, the monitoring includes detecting a state of the one or more third-party applications running on the first endpoint device. In some embodiments, the state of the one or more third-party applications includes an identification of a suspicious activity, a software version, or a connection status. The monitoring can also comprise checking, by the first software agent, a compliance of the first endpoint device against a security standard. The security standard can be associated with internal policies; regulatory, audit, or third-party organization recommendations; and so on. The security standards can include the ISO 27000 series, NIST SP 800-53, NIST SP 800-171, COBIT, CIS Version 8, HITRUST, etc. Recommendations from the third-party application vendor can be used as a security standard. The checking can be based on a schedule. The schedule can be set for individual third-party applications or can be based on a standard for application types.

The system 800 includes a sending component 850. The sending component includes functions and instructions for sending, to the orchestration software, by the first software agent, a plurality of security information details, wherein the plurality of security information details includes the activity that was monitored. The plurality of security information details can include the endpoint device hostname, IP address, kernel, agent version, agent status, or a last internet connection. Information about the type of endpoint device, the operating system, network connection, physical location, and so on can be included in the security information details. The security information details can be refreshed based on a schedule established by the orchestration software. In embodiments, one or more software agents communicate with the orchestration software asynchronously. This allows the orchestration software the ability to communicate with multiple endpoint devices simultaneously and coordinate actions to remedy security incidents quickly and efficiently.

The system 800 includes a summarizing component 860. The summarizing component includes functions and instructions for summarizing, by the orchestration software, the plurality of security information details from the first software agent. Summarized information can include the number of endpoint devices on the network, number of active endpoint devices, number of security related events, number of blocked commands, number of allowed commands, and so on. In embodiments, the summarizing comprises listing the state of the one or more third-party applications running on the first endpoint device. In embodiments, the state of the one or more third-party applications includes an identification of a suspicious activity, a software version, or a connection status.

The system 800 includes a taking actions component 870. The taking actions component includes functions and instructions for taking an action, on the first endpoint device, wherein the action is based on the summarizing, wherein the action is initiated by the orchestration software, and wherein the action is performed by the first software agent. In embodiments, the action is responsive to a security incident. In further embodiments, the action includes isolating the first endpoint device. Based on the security incident, the software agent and orchestrator software can install, update, uninstall, or remove third-party software as required. In embodiments, the taking actions component further comprises taking a second action on the first endpoint device. The second action can be based on a plurality of security information details from the first software agent.

The system 800 can include a computer system for software deployment comprising: a memory which stores instructions; one or more processors coupled to the memory wherein the one or more processors, when executing the instructions which are stored, are configured to: install a software agent on each endpoint device within a plurality of endpoint devices, wherein each software agent remotely manages a unique endpoint device within the plurality of endpoint devices, and wherein each software agent is communicatively coupled to an orchestration software running on a compute device; provide a software access, wherein the software access enables, on one or more endpoint devices within the plurality of endpoint devices, one or more third-party applications, and wherein the one or more third-party applications communicate with each software agent installed on the one or more endpoint devices; monitor, by a first software agent installed on a first endpoint device within the one or more endpoint devices, an activity by the one or more third-party applications on the first endpoint device; send, to the orchestration software, by the first software agent, a plurality of security information details, wherein the plurality of security information details includes the activity that was monitored; summarize, by the orchestration software, the plurality of security information details from the first software agent; and take an action, on the first endpoint device, wherein the action is based on the summarizing, wherein the action is initiated by the orchestration software, and wherein the action is performed by the first software agent.

The system 800 can include a computer program product embodied in a non-transitory computer readable medium for software deployment, the computer program product comprising code which causes one or more processors to perform operations of: installing a software agent on each endpoint device within a plurality of endpoint devices, wherein each software agent remotely manages a unique endpoint device within the plurality of endpoint devices, and wherein each software agent is communicatively coupled to an orchestration software running on a compute device; providing a software access, wherein the software access enables, on one or more endpoint devices within the plurality of endpoint devices, one or more third-party applications, and wherein the one or more third-party applications communicate with each software agent installed on the one or more endpoint devices; monitoring, by a first software agent installed on a first endpoint device within the one or more endpoint devices, an activity by the one or more third-party applications on the first endpoint device; sending, to the orchestration software, by the first software agent, a plurality of security information details, wherein the plurality of security information details includes the activity that was monitored; summarizing, by the orchestration software, the plurality of security information details from the first software agent; and taking an action, on the first endpoint device, wherein the action is based on the summarizing, wherein the action is initiated by the orchestration software, and wherein the action is performed by the first software agent.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for software deployment comprising:
installing a software agent on each endpoint device within a plurality of endpoint devices, wherein each software agent remotely manages a unique endpoint device within the plurality of endpoint devices, and wherein each software agent is communicatively coupled to an orchestration software running on a compute device;
providing software access, wherein the software access enables, on one or more endpoint devices within the plurality of endpoint devices, one or more third-party applications, and wherein the one or more third-party applications communicate with each software agent installed on the one or more endpoint devices;
monitoring, by a first software agent installed on a first endpoint device within the one or more endpoint devices, an activity by the one or more third-party applications on the first endpoint device;
sending, to the orchestration software, by the first software agent, a plurality of security information details, wherein the plurality of security information details includes the activity that was monitored;
summarizing, by the orchestration software, the plurality of security information details from the first software agent; and
taking an action, on the first endpoint device, wherein the action is based on the summarizing, wherein the action is initiated by the orchestration software, and wherein the action is performed by the first software agent.

2. The method of claim 1 further comprising detecting, on the first endpoint device, by the software agent, a suspicious activity on the first endpoint device.

3. The method of claim 2 further comprising blocking, by the orchestration software, the suspicious activity, wherein the blocking is based on the detecting.

4. The method of claim 1 further comprising identifying, on the first endpoint device, by the one or more third-party applications, a suspicious activity on the first endpoint device.

5. The method of claim 4 further comprising quantifying the suspicious activity and providing results of the quantifying to the orchestration software.

6. The method of claim 4 further comprising blocking, by the one or more third-party applications, the suspicious activity, wherein the blocking is accomplished by the first software agent.

7. The method of claim 6 further comprising reporting, by the first software agent, the blocking to the orchestration software.

8. The method of claim 7 further comprising approving, by a user, in the orchestration software, the suspicious activity.

9. The method of claim 8 further comprising communicating, by the orchestration software, to the first software agent, the approving.

10. The method of claim 9 further comprising allowing, by the first software agent, the suspicious activity on the first endpoint device to proceed.

11. The method of claim 1 wherein the monitoring includes detecting a state of the one or more third-party applications running on the first endpoint device.

12. The method of claim 11 wherein the summarizing comprises listing the state of the one or more third-party applications running on the first endpoint device.

13. The method of claim 11 wherein the state of the one or more third-party applications includes an identification of a suspicious activity, a software version, or a connection status.

14. The method of claim 1 wherein the monitoring comprises checking, by the first software agent, a compliance of the first endpoint device against a security standard.

15. The method of claim 1 wherein the action includes updating a software application on the first endpoint device.

16. The method of claim 15 further comprising pushing, by the first software agent, the software update to the first endpoint device.

17. The method of claim 16 wherein the software update includes the one or more third-party applications installed on the first endpoint device.

18. The method of claim 1 wherein the action includes installing a software application on the first endpoint device.

19. The method of claim 1 wherein the action includes removing a software application from the first endpoint device.

20. The method of claim 1 wherein the action is responsive to a security incident.

21. The method of claim 20 wherein the action includes isolating the first endpoint device.

22. The method of claim 1 further comprising monitoring, by a second software agent installed on a second endpoint device within the one or more endpoint devices, an activity by one or more third-party applications on the second endpoint device; sending, to the orchestration software, by the second software agent, a plurality of security information details, wherein the plurality of security information details includes the activity that was monitored; summarizing, by the orchestration software, the plurality of security information details from the second software agent; and taking an action, on the second endpoint device, wherein the action is based on the summarizing, wherein the action is initiated by the orchestration software, and wherein the action is performed by the second software agent.

23. The method of claim 22 wherein the first software agent and the second software agent communicate with the orchestration software asynchronously.

24. The method of claim 1 further comprising taking a second action on the first endpoint device.

25. The method of claim 1 wherein the providing includes an application programming interface (API).

26. A computer program product embodied in a non-transitory computer readable medium for software deployment, the computer program product comprising code which causes one or more processors to perform operations of:
installing a software agent on each endpoint device within a plurality of endpoint devices, wherein each software agent remotely manages a unique endpoint device within the plurality of endpoint devices, and wherein each software agent is communicatively coupled to an orchestration software running on a compute device;
providing a software access, wherein the software access enables, on one or more endpoint devices within the plurality of endpoint devices, one or more third-party applications, and wherein the one or more third-party applications communicate with each software agent installed on the one or more endpoint devices;
monitoring, by a first software agent installed on a first endpoint device within the one or more endpoint devices, an activity by the one or more third-party applications on the first endpoint device;
sending, to the orchestration software, by the first software agent, a plurality of security information details, wherein the plurality of security information details includes the activity that was monitored;
summarizing, by the orchestration software, the plurality of security information details from the first software agent; and
taking an action, on the first endpoint device, wherein the action is based on the summarizing, wherein the action is initiated by the orchestration software, and wherein the action is performed by the first software agent.

27. A computer system for software deployment comprising:
a memory which stores instructions;
one or more processors coupled to the memory wherein the one or more processors, when executing the instructions which are stored, are configured to:
install a software agent on each endpoint device within a plurality of endpoint devices, wherein each software agent remotely manages a unique endpoint device within the plurality of endpoint devices, and wherein each software agent is communicatively coupled to an orchestration software running on a compute device;
provide a software access, wherein the software access enables, on one or more endpoint devices within the plurality of endpoint devices, one or more third-party applications, and wherein the one or more third-party applications communicate with each software agent installed on the one or more endpoint devices;
monitor, by a first software agent installed on a first endpoint device within the one or more endpoint devices, an activity by the one or more third-party applications on the first endpoint device;
send, to the orchestration software, by the first software agent, a plurality of security information details, wherein the plurality of security information details includes the activity that was monitored;
summarize, by the orchestration software, the plurality of security information details from the first software agent; and
take an action, on the first endpoint device, wherein the action is based on the summarizing, wherein the action is initiated by the orchestration software, and wherein the action is performed by the first software agent.
